(19) United States
(12) Patent Application Publication
(10) Pub. No.: US 2007/0207843 A1
(43) Pub. Date: Sep. 6, 2007

(54) Multi-disc changer for computer gaming device

(76) Inventor: Paul Jin Hwang, Burbank, CA (US)

Correspondence Address: ROGITZ & ASSOCIATES, 750 B STREET, SUITE 3120, SAN DIEGO, CA, 92101, US

(21) Appl. No.: 11/368,238

(22) Filed: Mar. 3, 2006

(51) Int. Cl. A63F 13/00

(52) U.S. Cl. 463/1; 463/43

(57) ABSTRACT

A disc changer is provided with a game console and stores all of a user's game discs, DVDs, CDs, etc. The system stores disc metadata so that the user can be presented with a screen shot listing the available discs and can select a disc from the screen shot for playing. In this way, the user can easily manage and select not only computer games to be played by the game console but also movie DVDs to be played on an associated TV, audio CDs, etc.

### FIELD OF THE INVENTION

The present invention relates generally to multi-disc changers for computer gaming devices.

### BACKGROUND OF THE INVENTION

Computer gaming systems such as Sony's Playstation® system (of various model numbers) have been provided to enable consumers to insert game discs into the gaming system and have game graphics displayed on a TV. As recognized herein, a large number of individual game discs can be problematic to store, and can require manually switching out discs every time a different game is desired to be played. The same problem remains if a consumer wishes to watch a DVD using a gaming console, or if the consumer wishes to play back an audio CD or picture disc. With these critical recognitions in mind, the solution herein is provided.

### SUMMARY OF THE INVENTION

The present invention solves the above-noted problems by providing a storage place for all the user's games and, if desired, DVDs, and CDs, and by making the transition between each piece of media seamless. Furthermore, the invention may display metadata for each disc to allow a user to quickly sort and search through the discs.

Accordingly, a system includes a game console configured to play computer games stored on discs. A disc changer in the system holds plural discs and communicates with the game console to play a user-selected one of the discs.

In non-limiting embodiments the discs in the disc changer can include computer game discs, movie DVDs, and audio CDs. The game console can cause data on the discs to be presented on a TV system. In a non-limiting implementation the game console includes a processor and the disc changer includes a disc drive configured to engage a disc in the disc changer, with the processor of the game console receiving information from the disc drive of the disc changer. Preferably, the game console and/or disc changer stores metadata pertaining to the discs for presenting metadata in a screen display from which a user can select a disc for playing. The game console and disc changer may be sold in a kit.

In another aspect, a kit includes a game console configured to cause multimedia streams to be presented on a TV, and a disc changer configured for holding plural discs and communicating information from disc to the game console for presentation of the information on a TV.

In yet another aspect, a system includes a TV and a game console communicating with the TV. The system also includes a disc changer holding plural discs and communicating with the game console. The game console causes information from a computer game disc in the disc changer to be presented on the TV.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting implementation of the present system;

FIG. 2 is a flow chart showing non-limiting logic of the present invention; and

FIG. 3 is a screen shot of a gallery display, showing available discs in the changer.

### DETAILED DESCRIPTION OF THE PREFERRED EMBODIMENT

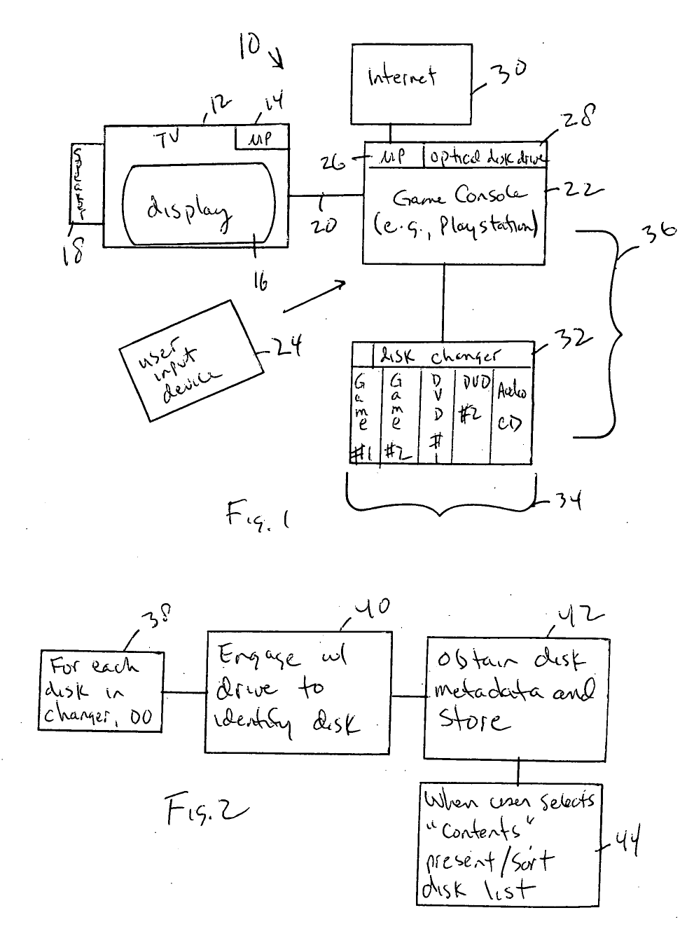

Referring initially to FIG. 1, a system is shown, generally designated 10, that can include a TV system 12 including a TV processor 14, video display 16 such as a TV screen, and audio display 18 such as one or more audio speakers. The TV system 12 can communicate over a link 20 with a game console 22 to present audio and video information from the game console 22. The link 20 can be, without limitation, a High Definition Multimedia Interface (HDMI)/Digital Visual Interface (DVI) link.

The game console 22 may be, without limitation, a Sony Playstation, a Microsoft X-Box, or a Nintendo Game Cube. These console names are trademarked. In any case, by “game console” is meant a non-PC device that accesses a computer storage device, such as an optical disc or other storage medium which bears interactive programs, and generates multimedia streams in response to both the program and to user-input interactive signals from, e.g., a hand-held commander 24, for presentation of the multimedia on a TV system. In essence, the user-input interactive signals are used at least in part to determine how characters and objects in the computer game program move, behave, and otherwise interact with each other when displayed on the TV system 12, with game objects also moving and interacting with each other in accordance with preprogrammed instructions.

The game console 22 may include, without limitation, a game processor 26 and an optical disc drive 28 such as but not limited to a Blu-Ray drive. In some implementations the game console 22 can communicate with the Internet 30 for purposes to be shortly disclosed.

In accordance with the present invention, the game console 22 communicates with a disc changer 32 that holds multiple optical discs 34, any one of which can be read by an optical drive 35, it being understood that the disc changer 32 can have more than a single drive 35. As shown, the optical discs 34 may include computer game discs, movie DVDs, audio CDs, universal media disc (UMD), picture discs, mini-CDs, mini-DVDs, HD-DVD, or any appropriate disc type particularly if used for games. In one non-limiting embodiment, the disc changer 32 communicates with the game console 22 over a IEEE-1394 link, while in other embodiments other types of links may be used, e.g., universal serial bus (USB) links or wireless links. Thus, information from a disc 34 in the optical drive 35 of the disc changer 32 can be communicated to the game console 22 for playing, in lieu of directly inserting the disc into the optical drive 28 of the game console 22. The disc changer 32 may be sold to a consumer in a kit 36 along with the game console 22 as shown.

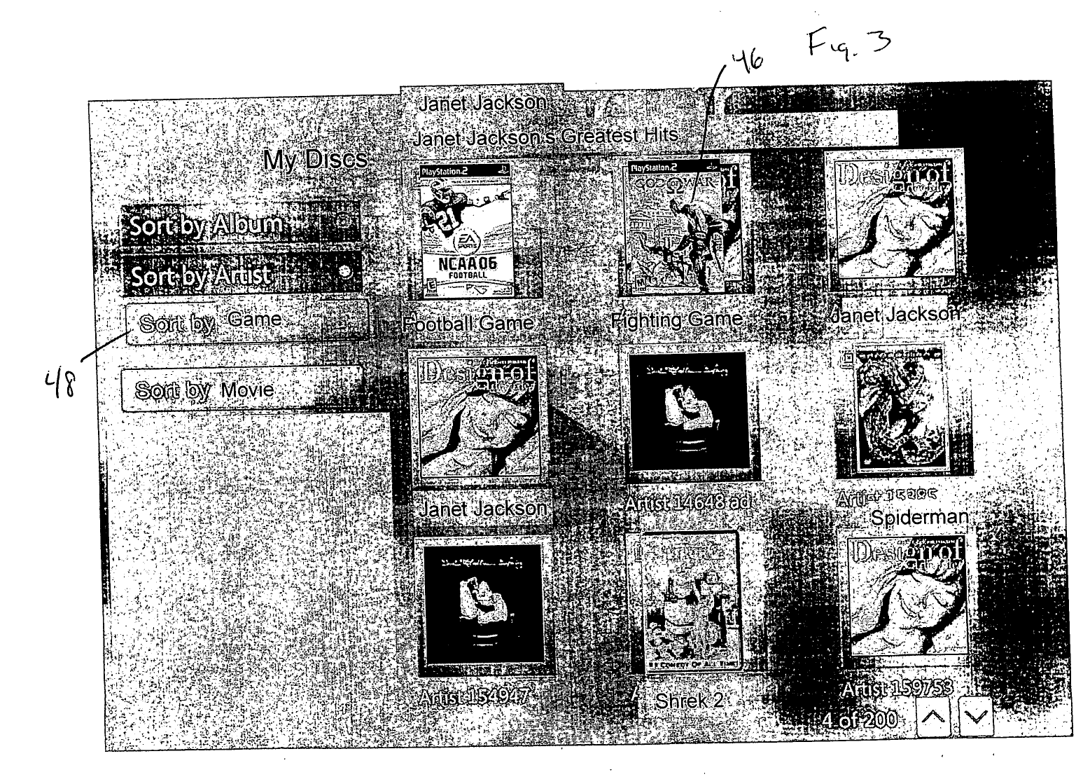

The operation of the system 10 can be best understood in reference to FIG. 2, wherein at block 38, for each disc 34 that has been loaded into the disc changer 32, a loop is entered in which the disc is engaged with the optical disc drive 35 of the disc changer 32. The DO loop shown in FIG. 2 can be undertaken by prompting a person to load each disc one by one into the optical drive 35, or it can be undertaken automatically by the game console 22 in response to an initiation command or periodically or whenever it is sensed that a new disc has been loaded into the disc changer 32. In any case, once engaged with the optical drive, the disc is identified, and at block 42 its metadata is obtained and stored. The metadata, which may include, e.g., game or movie or audio album cover picture, title, publisher, rating, etc., may be available on the disc itself or, once the disc is identified, the game console 22 may access the Internet 30 to obtain the metadata. Yet again, regardless of where a disc's metadata is initially obtained by the system 10, the game console 22 may periodically access the Internet 30 to obtain updates to the metadata. In any case, the metadata may be stored in the game console 22 or disc changer 32 or other storage of the system 10 for display thereof at block 44 when, for example, a user manipulates the user input device 24 to input a command to view the content (e.g., a list of discs) in the disc changer 32.

FIG. 3 shows a non-limiting screen display that may be presented on the display 16 of the TV system 12 in response to a command to view the content in the disc changer 32. As shown, the metadata obtained at block 42 of FIG. 2 may be presented in the form of thumbnails 46, which may be derived from game or movie or audio album cover pictures. Below each thumbnail 46 may the title of the game, movie, album, etc. or a generic description of the subject matter of the disc (e.g., “game”, “movie”, etc.) Buttons 48 may be presented on the display as shown to enable the consumer to elect how to sort the metadata, e.g., by album, by artists, by game (games first, movies following, etc.), by movie, or by other genre type, etc. To play a game or movie, the consumer need simply click on the associated thumbnail, in response to which the game console loads the disc from the disc changer into the optical drive and plays it.

Accordingly, the present game console 22 with disc changer 32 allows users to store all of their game/movie/audio discs, see the metadata for their discs (game art, title, rating, publisher, etc.), and give the users a software gallery/page to be able to playback any of the media seamlessly. The system also makes the transition between each piece of media seamless. By showing the metadata for each disc, it also allows the user to quickly sort and search through their discs to find what type of experience they want to start.

While the particular MULTI-DISC CHANGER FOR COMPUTER GAMING DEVICE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A system, comprising:
a game console configured to play at least one computer game stored on at least one disc; and
a disc changer holding plural discs and communicating with the game console to play a user-selected one of the discs.

2. The system of claim 1, wherein the discs in the disc changer include at least one computer game disc and at least one movie DVD.

3. The system of claim 1, wherein the game console causes a display of data on at least one disc to be presented on a TV system.

4. The system of claim 2, wherein the discs in the disc changer include at least one audio CD.

5. The system of claim 1, wherein the game console includes at least one processor and the disc changer includes at least one disc drive configured to engage at least one disc in the disc changer, the processor of the game console receiving information from the disc drive of the disc changer.

6. The system of claim 1, wherein the game console and disc changer are sold in a kit.

7. The system of claim 1, wherein the game console and/or disc changer stores metadata pertaining to the discs for presenting metadata in a screen display from which a user can select a disc for playing.

8. The system of claim 1, wherein at least one disc is a movie DVD, and the game console causes information from the movie DVD to be played on a TV system.

9. The system of claim 7, wherein the user can sort metadata in the screen display by disc genre.

10. A kit, comprising:
a game console configured to cause multimedia streams to be presented on a TV; and
a disc changer configured for holding plural discs and communicating information from at least one disc to the game console, for presentation of the information on a TV.

11. The kit of claim 10, wherein a user may select, using a screen display, which disc in the disc changer to play using the game console.

12. The kit of claim 11, wherein the game console is configured to cause metadata pertaining to discs in the disc changer to be presented in a screen display on the TV.

13. The kit of claim 12, wherein at least one disc can be a game disc and at least one disc can be a movie disc.

14. The kit of claim 13, wherein the game console can cause information from a movie DVD in the disc changer to be played on a TV system.

15. The kit of claim 14, wherein the user can sort metadata in a screen display by disc genre.

16. A system, comprising:
a TV;
at least one game console communicating with the TV; and
at least one disc changer holding plural discs and communicating with the game console, the game console causing information from at least one computer game disc in the disc changer to be presented on the TV.

17. The system of claim 16, wherein the discs in the disc changer include at least one computer game disc and at least one movie DVD.

18. The system of claim 16, wherein the game console causes a display of data on at least one disc to be presented on the TV.

19. The system of claim 16, wherein the game console includes at least one processor and the disc changer includes at least one disc drive configured to engage at least one disc in the disc changer, the processor of the game console receiving information from the disc drive of the disc changer.

20. The system of claim 16, wherein the game console and/or disc changer stores metadata pertaining to the discs for presenting metadata in a screen display from which a user can select a disc for playing, wherein the user can sort metadata in the screen display by disc genre.
